(19) United States
(12) Patent Application Publication
(10) Pub. No.: US 2020/0023271 A1
(43) Pub. Date: Jan. 23, 2020

(54) DISPLAY SYSTEM

(71) Applicant: SEIKO EPSON CORPORATION, Tokyo (JP)

(72) Inventors: Shunji KAMIJIMA, Suwa-gun (JP); Yuri MAKITA, Chino-shi (JP); Akihiko YAMAMOTO, Higashichikuma-gun (JP)

(73) Assignee: SEIKO EPSON CORPORATION, Tokyo (JP)

(21) Appl. No.: 16/515,401

(22) Filed: Jul. 18, 2019

(30) Foreign Application Priority Data
Jul. 19, 2018 (JP) 2018-135586

(51) Int. Cl. A63F 13/285; G08B 6/00; G02B 5/02

(52) U.S. Cl. CPC A63F 13/285; H04N 9/3179; G02B 5/0284; G08B 6/00

(57) ABSTRACT

A display system includes a projector configured to project image light and a reflector including a gripper and a reflection surface over which a reflective material having light scattering capability is uniformly disposed.

The present application is based on, and claims priority from JP Application Serial Number 2018-135586, filed Jul. 19, 2018, the disclosure of which is hereby incorporated by reference herein in its entirety

### BACKGROUND

### 1. Technical Field

The present invention relates to a display system.

### 2. Related Art

There has been a known system that projects video images on a predetermined projection surface to perform video-based rendition. For example, the video rendition system described in WO2006/006642 detects, when a moving object comes into contact with a floor surface or a step-on surface, the position, size and shape of a portion of the moving object that is the portion having come into contact with the floor surface or the step-on surface and processes a video material in correspondence with the detected position, size and shape of the contact portion of the moving object. The video rendition system then projects a video signal produced by processing the video material in the form of video images on the floor surface or the step-on surface.

WO2006/006642 is an example of the related art.

The video rendition system described in WO2006/006642, however, requires an apparatus that detects the position, size and shape of a portion of the moving object that is the portion having come into contact with the floor surface or the step-on surface and an apparatus that processes a video material in correspondence with the detected position, size and shape of the contact portion. It is therefore necessary to construct a large-scale system, which is difficult to achieve.

### SUMMARY

An advantage of some aspects of the present disclosure is to provide a simple configuration that provides a user with fun and enjoyment, such as those provided by a game, by using an image projected by a projector.

A display system according to an aspect of the present disclosure includes a projector configured to project image light and a reflector including a gripper and a reflection surface over which a reflective material having light scattering capability is uniformly disposed.

In the aspect of the present disclosure, a light storing material may be added to the reflective material or part thereof.

In the aspect of the present disclosure, the reflection surface may have a first area and a second area having reflectance lower than reflectance of the first area.

In the aspect of the present disclosure, the first area may be formed in a central area containing a center of the reflection surface, and the second area may be formed around the first area.

In the aspect of the present disclosure, the display system may further include a light receptor that receives light with which the reflection surface is irradiated, a vibration section that produces vibration to cause the gripper to vibrate, and a controller that causes the vibration section to vibrate based on a result of the light reception performed by the light receptor.

In the aspect of the present disclosure, the projector may project the image light on a projection surface in the form of motion images or partial motion images so produced that a specific portion of an image moves.

In the aspect of the present disclosure, part of the reflection surface may transmit the image light and scatter the transmitted image light toward a side of the reflection surface that is a side opposite a side irradiated with the image light.

### BRIEF DESCRIPTION OF THE DRAWINGS

FIG. 1 is a system configuration diagram of a display system.

FIG. 2 is another system configuration diagram of the display system.

FIG. 3 is a configuration diagram showing a schematic configuration of a projector.

FIG. 4 is a perspective view showing the configuration of a reflector.

FIG. 5 is a perspective view showing another configuration of the reflector.

FIG. 6 shows the configuration that causes a gripper to vibrate.

FIG. 7 shows an image projected by the projector.

FIG. 8 shows the image projected by the projector.

FIG. 9 shows another image projected by the projector.

FIG. 10 shows another image projected by the projector.

### DESCRIPTION OF EXEMPLARY EMBODIMENTS

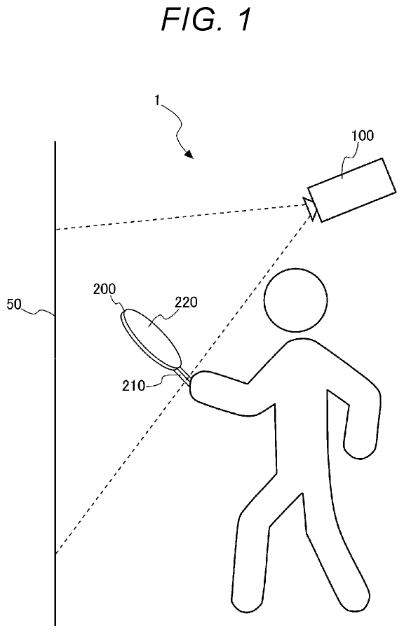

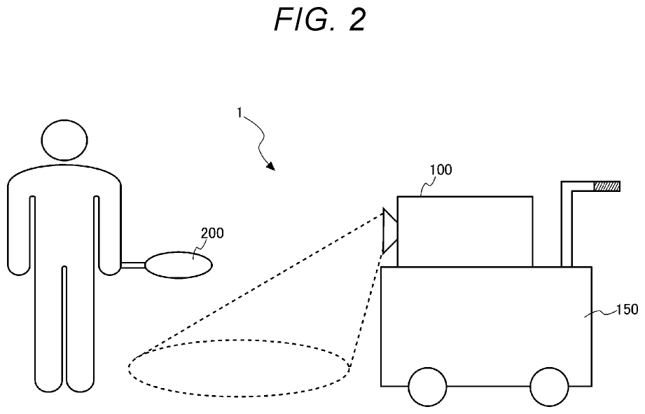

An embodiment of the present disclosure will be described below with reference to the accompanying drawings. FIGS. 1 and 2 are system configuration diagrams of a display system 1 according to the embodiment.

The display system 1 includes a projector 100, which projects image light on a projection surface 50, and a reflector 200, which is grasped by a user with a hand when used.

The projector 100 in the present embodiment is so installed as to be hung down from a ceiling and projects image light toward the projection surface 50, such as a wall surface and a screen, as shown in FIG. 1.

The method for installing the projector 100 is not limited to the ceiling hanging installation and may instead be flat surface installation in which the projector 100 is installed on a flat surface such as a floor or a stand or wall mounting installation in which the projector 100 is mounted on a wall surface. Instead, the projector 100 may be placed on a moving object 150, and the projector 100 may be configured to be movable in accordance with movement of the moving object 150, as shown in FIG. 2.

The projection surface 50, on which the projector 100 projects image light, may be a wall surface, a ceiling surface, a floor surface, or any other surface of a room where the projector 100 is installed or a screen, a flat curtain, a plate surface, or any other flat surface. The projection surface 50 may instead be an uneven surface, such as an exterior surface of a building. FIG. 2 shows a case where the projection surface 50 is a floor surface.

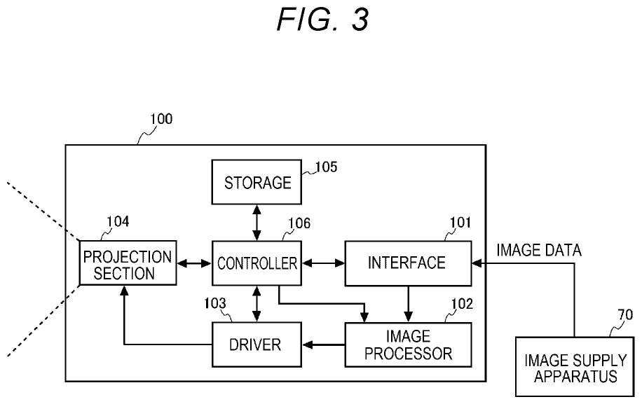

FIG. 3 is a configuration diagram showing a schema of the configuration of the projector 100.

The projector 100 includes an interface 101, an image processor 102, a driver 103, a projection section 104, a storage 105, and a controller 106.

The interface 101 includes a connector for wired connection and an interface circuit corresponding to the connector, and the interface 101 is wired to an image supply apparatus 70, which supplies the projector 100 with image data. The connector and the interface circuit are not shown in FIG. 3. FIG. 3 shows a case where the projector 100 is wired to the image supply apparatus 70, and the projector 100 may instead be wirelessly connected to the image supply apparatus 70. For example, in the case where the projector 100 is placed on the moving object 150 and the projector 100 is moved along with the moving object 150, as shown in FIG. 2, wireless connection is an effective connection method.

The image processor 102 develops the image data inputted via the interface 101 in a frame memory that is not shown and performs resolution conversion, resizing, distortion correction, color tone and luminance adjustment, and other types of other image processing under the control of the controller 106. The image processor 102 outputs the processed image data to the driver 103.

The driver 103 draws an image based on the image data inputted from the image processor 102 on a liquid crystal panel provided in the projection section 104. The liquid crystal panel is not shown in FIG. 3.

The projection section 104 includes a light source, the liquid crystal panel, and a projection system. In the projection section 104, the liquid crystal panel on which the image has been drawn modulates light emitted from the light source to produce image light. The projection section 104 projects the produced image light on the projection surface via the projection system. The light source or the projection system is not shown in FIG. 3.

The present embodiment will be described with reference to a case where the image based on the image data supplied from the image supply apparatus 70 is projected on the projection surface 50 by the projector 100, and image data to be projected on the projection surface 50 may instead be stored in the storage 105 in advance. In this case, the image processor 102 processes the image data read by the controller 106 from the storage 105 and outputs the processed image data to the driver 103.

The storage 105 is a nonvolatile storage device and stores, for example, a control program executed by the controller 106, data processed by the processor 106, and image data.

The controller 106 is a computer device including a CPU (central processing unit), a ROM (read only memory), a RAM (random access memory), and other components. The ROM stores a variety of control programs executed by the CPU. The CPU executes the control programs to perform a variety of types of computation. The RAM stores data, such as the results of the computation performed by the CPU.

The controller 106 controls the interface 101, the image processor 102, the driver 103, and the projection section 104 to cause them to project an image based on the image data supplied from the image supply apparatus 70 on the projection surface 50. Specifically, the controller 106 outputs a parameter used in image processing performed by the image processor 102 to the image processor 102 and controls the driver 103 to cause the liquid crystal panel to draw the image data processed by the image processor 102. The controller 106 further controls the projection section 104 to adjust the magnification factor of the projected image and perform focus adjustment.

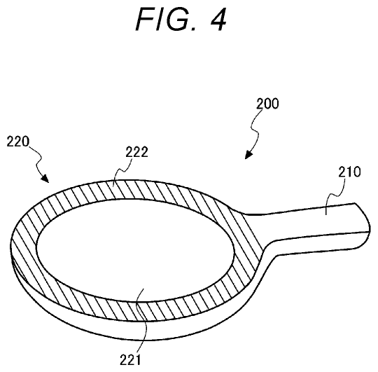

FIG. 4 is a perspective view showing the reflector 200.

The reflector 200 will next be described with reference to FIG. 4. The reflector 200 includes a gripper 210 and a reflection surface 220.

The gripper 210 is a holding portion held with a hand that holds the reflector 200. FIG. 4 shows the rod-shaped gripper 210, which protrudes outward from the reflection surface 220, but does not necessarily have a specific shape and may have any shape that allows the user to hold the gripper 210 with a hand.

The reflection surface 220 has light scattering capability. The light scattering capability is capability to scatter at least part of light with which the reflection surface 220 is irradiated to produce light formed of random directional components. The reflection surface 220 has a first area 221 and a second area 222. The first area 221 is provided in a central area that is an area containing the center of the reflection surface 220, and the second area 222 is so provided as to surround the circumference of the first area 221.

The reflectance of the first area 221 is higher than the reflectance of the second area 222. For example, to form the reflection surface 220 by attaching white paper on a surface of the reflector 200, white paper called hosho-gami and having high reflectance can be used. The second area 222 can be made, for example, of white art paper or paper called shoji-gami having reflectance lower than that of the white hosho-gami. The white hosho-gami, white art paper, and shoji-gami which are used in the first area 221 and the second area 222 are each a reflective material having the light scattering capability, and any of them is attached onto a surface of the reflector 200. A reflective material having the light scattering capability is thus uniformly disposed on the reflection surface 220.

Instead, to form the reflection surface 220, for example, by attaching white cloth onto a surface of the reflector 200, white flannel cloth having high reflectance can be used as a material that forms the first area 221. On the other hand, the second area 222 can be made, for example, of cotton or hemp cloth having reflectance lower than that of white flannel cloth. The white flannel cloth, cotton, or hemp cloth used to form the first area 221 and the second area 222 is a reflective material having the light scattering capability and is attached onto a surface of the reflector 200. A reflective material having the light scattering capability is thus uniformly disposed on the reflection surface 220.

On the other hand, at least one of the first area 221 and the second area 222 can instead be made of a material that can transmit part of the light incident thereon and scatter the transmitted light toward a side of the reflection surface 220 that is the side opposite the light incident side. Examples of the material that allows the transmission and scattering may include ground glass and tracing paper having a reflectance of 25%, shoji-gami paper having a reflectance ranging from 30 to 50%, white silk having a reflectance ranging from 60 to 70%, hemp having a reflectance ranging from 40 to 70%, and cotton fabric. A volume-diffusion-type, thick material, such as a cloth material, blurs video images and is therefore effective in producing video images that cause illusion and stirring an observer's imagination. Using such a material capable of transmitting and scattering part of the light with which the material is irradiated and observing the scattered light allows observation of a portion cut from video images, whereby the expandability of a game can be further enhanced.

In a case where the first area 221 has a reflectance of 10%, an image having an image contrast ratio close to 10:1 can be displayed on the reflection surface 220, whereby a clear image can be displayed on the reflection surface 220. In a case where the first area 221 is made of white art paper having a reflectance higher than or equal to 50%, the clarity of an image displayed on the reflection surface 220 is expected to be close to the clarity of a newspaper sheet. Further, in a case where the first area 221 is made of Kent paper or formed of a substrate onto which magnesium carbonate is applied and having a reflectance higher than or equal to 70%, higher-clarity, higher-resolution video images can be expected.

Setting the reflectance of the first area 221 to be higher than that of the second area 222 allows, when the reflector 200 is irradiated with the image light from the projector 100, the luminance of the image light with which the first area 221 is irradiated to be higher than the luminance of the image light with which the second area 222 is irradiated. The user can therefore manipulate the reflector 200 in such a way that the first area 221 is irradiated with the image light.

It is preferable that the reflectance of the first area 221 or both the first area 221 and the second area 222 is higher than the reflectance of the projection surface 50.

The configuration described above allows the user to recognize that the image light which is outputted from the projector 100 and with which the reflection surface 220 is irradiated has higher luminance than the image light which is outputted from the projector 100 and projected on the projection surface 50. The user can therefore recognize that the reflection surface 220 has been irradiated with the image light. Further, since the reflectance of the projection surface 50 is lower than the reflectance of the first area 221 or both the first area 221 and the second area 222, the feature of a game that causes the user to search for a desired image can be enhanced.

A net picture is printed on the second area 222. For example, to form the second area 222 by using art paper, art paper on which a net picture has been printed is attached to the second area 222 of the reflector 200. A net picture may instead be printed on each of the first area 221 and the second area 222.

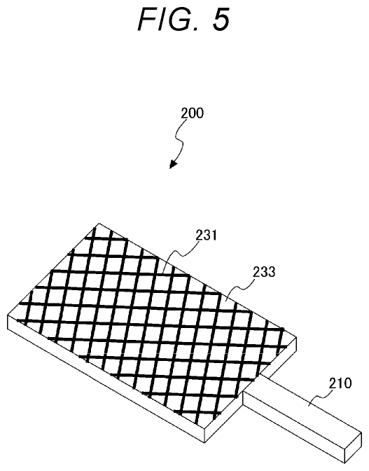

FIG. 5 is a perspective view showing another configuration of the reflector 200.

The reflector 200 may be so configured that a net picture is displayed on the reflection surface 220 when the reflection surface of the reflector 200 is irradiated with the image light from the projector 100.

For example, the reflection surface 220 is formed of two members having different reflectance values. Specifically, a high-reflectance member 233 is so attached as to entirely cover an underlying portion of the reflector 200, and a low-reflectance member 231 so cut to form meshes is attached onto the high-reflectance member 233. The high-reflectance member 233 can be the white hosho-gami paper or the white flannel cloth described above, and the low-reflectance member 231 can be the white art paper, the shoji-gami paper, the cotton, or the hemp cloth described above. In the configuration described above, when the reflection surface 220 is irradiated with the image light, the mesh-shaped, low-reflectance member 231 is darker than the underlying high-reflectance member 233, so that the meshes are displayed as a dark portion.

Conversely, the low-reflectance member 231 as the underlying portion may be so attached as to entirely cover the reflector 200, and the high-reflectance member 233 so cut as to form meshes maybe attached onto the low-reflectance member 231. In the configuration described above, when the reflection surface 220 is irradiated with the image light, the mesh-shaped, high-reflectance member 233 is brighter than the underlying low-reflectance member 231, so that the meshes are displayed as a bright portion.

The reflective material used to form the first area 221 or both the first area 221 and the second area 222 contains a light storing material. Specifically, a light storing material is applied onto white paper or white cloth used to form the first area 221 or both the first area 221 and the second area 222. The light storing material is therefore added to the first area 221 or both the first area 221 and the second area 222. The light storing material is, for example, a promethium compound, a zinc-sulfide-based phosphor, or a strontium aluminate.

When the first area 221 or both the first area 221 and the second area 222 are irradiated with the image light from the projector 100 for at least a fixed period, the light storing material causes the first area 221 or both the first area 221 and the second area 222 to shine for a fixed period. Thereafter, even when the user moves the reflector 200 so that the reflector 200 is not irradiated with the image light any more, the first area 221 or both the first area 221 and the second area 222 shine for the fixed period. Instead, even when the reflector 200 is not irradiated with the image light any more, an image corresponding to the image light with which the reflector 200 has been irradiated is displayed as an afterimage in the first area 221 or both the first area 221 and the second area 222. The reason for this is that the first area 221 or both the first area 221 and the second area 222 contain the light storing material.

The reflection surface 220 shown in FIG. 4 has a circular shape, and the reflection surface 220 shown in FIG. 5 has a rectangular shape, but the reflection surface 220 does not necessarily have a specific shape and can have an arbitrary shape. For example, the reflection surface 220 may have a triangular shape, a pentagonal shape, or any other polygonal shape.

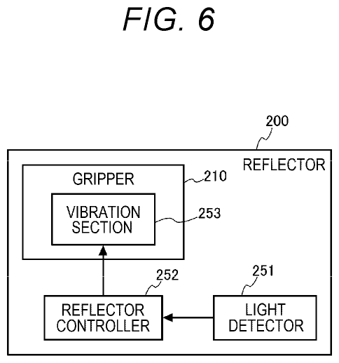

FIG. 6 shows the configuration that causes the gripper 210 to vibrate.

The reflector 200 includes a vibration section 253, and when the first area 221 or both the first area 221 and the second area 222 are irradiated with light having a color set in advance or light having optical intensity set in advance, the vibration section 253 vibrates. The reflector 200 includes a light detector 251, a reflector controller 252, and the vibration section 253.

The light detector 251 acts as the “light receptor” in an aspect of the present disclosure and is formed, for example, of a light receiving device, such as a photodiode and a photoresistor. The light detector 251 detects the intensity of the light with which the first area 221 or both the first area 221 and the second area 222 are irradiated and outputs a signal corresponding to the detected intensity of the light. Instead, the light detector 251 outputs a signal when the first area 221 or both the first area 221 and the second area 222 are irradiated with the light having a color set in advance. The signal outputted by the light detector 251 is converted into a digital signal, and the digital signal is inputted to the reflector controller 252. The signal inputted to the reflector controller 252 is called a detected signal.

The reflector controller 252 acts as the “controller” in an aspect of the present disclosure and causes the vibration section 253 to vibrate based on the result of the light reception performed by the light detector 251. Specifically, the reflector controller 252 compares the value of the inputted detected signal with a threshold set in advance and outputs a drive signal that drives the vibration section 253 to the vibration section 253 when the value of the detected signal is greater than the threshold. The vibration section 253 functions as what is called a vibrator and vibrates when the drive signal is inputted from the reflector controller 252 to the vibration section 253, and the vibration is transmitted to a hand of the user who grips the gripper 210.

The vibration section 253 can have a generally known configuration as the vibrator, such as an eccentric motor, a linear vibrator, and a piezoelectric device. FIG. 6 shows no eccentric motor, linear vibrator, or piezoelectric device.

An eccentric motor is configured to produce vibration by rotating a rotary shaft to which a weight having eccentric shape is attached. A linear vibrator is configured to produce vibration by causing current to flow through a coil to produce electromagnetic force and using the produced electromagnetic force and repulsive force produced by a magnet to cause the coil itself to vibrate upward and downward. A piezoelectric device is configured to produce vibration by using a piezoelectric device that mechanically extends and contracts when voltage is applied thereto.

In the display system 1 according to the present embodiment, the projector 100 projects image light on the projection surface 50. An image based on the image light is displayed on the projection surface 50. The image displayed on the projection surface 50 may be motion images based on motion image data or partial motion images so produced that a specific part of a still image moves. The partial motion images are GIF-animation (GIF stands for Graphics Interchange Format) images that express motion using a plurality of concatenated GIF images. The partial motion images may instead be cinema-graphic images only part of which moves based on motion image data.

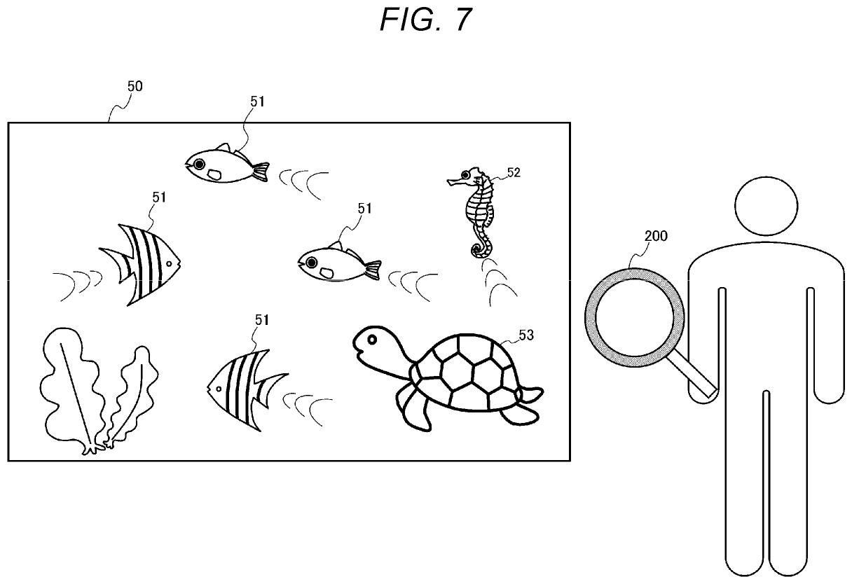

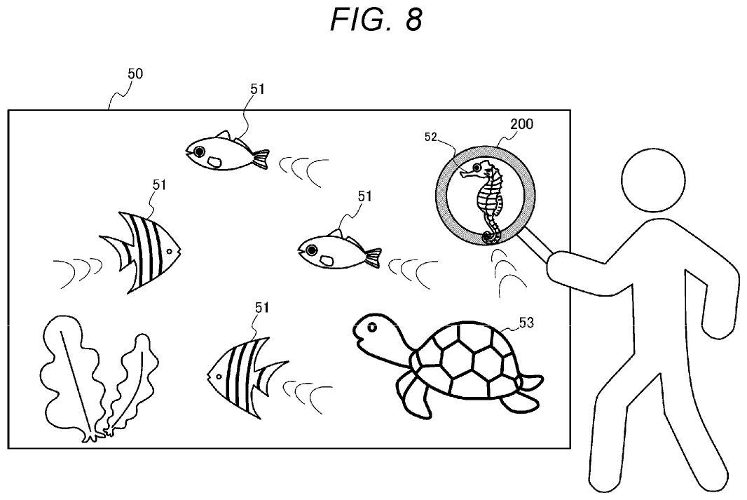

FIGS. 7 and 8 show an image projected by the projector 100.

The following description will be made with reference to a case where an image of creatures, such as see-swimming fishes, is projected on the projection surface 50, as shown in FIG. 7. In the following description, the image projected on the projection surface 50 is called as a whole an overall image, and images of the creatures, such as a fish 51, a seahorse 52, and a tortoise 53, are called partial images. The position where each of the partial images showing the fish 51, the seahorse 52, and the tortoise 53 is displayed changes in the overall image. That is, the partial images showing the fish 51, the seahorse 52, and the tortoise 53 are so displayed that they swim in the sea and move in the overall image.

The user holds the reflector 200 with ahead and moves the reflector 200 while viewing the image projected on the projection surface 50 to catch the fish 51, the seahorse 52, or the tortoise 53 swimming in the sea with the reflector 200. The user places the reflector 200, in more detail, the first area 221 in the position of the partial image showing the fish 51, the seahorse 52, or the tortoise 53 that the user desires to capture. For example, in a case where the user desires to capture the seahorse 52, the user moves the reflector 200 in such a way that the partial image showing the seahorse 52 is projected in the first area 221 of the reflection surface 220. FIG. 8 shows the state in which the partial image showing the seahorse 52 is projected in the first area 221 of the reflector 200.

The reflectance of the first area 221 is higher than the reflectance of the projection surface 50. Therefore, when the partial image showing the seahorse 52 is projected on the first area 221, the luminance of the partial image showing the seahorse 52 is higher than the luminance of the partial image showing the seahorse 52 having been projected on the projection surface 50. Further, when the partial image showing the seahorse 52 is projected on the first area 221, the value of the detected signal outputted by the light detector 251 becomes greater than the threshold set in advance, and the reflector controller 252 outputs the drive signal to the vibration section 253 to cause the vibration section 253 to vibrate. The gripper 210 is thus allowed to vibrate. The display system 1 can therefore impart a sensation that allows the user to feel as if the user caught the seahorse 52, whereby rendition that causes the user to feel as if the user caught a creature is achieved.

Further, the light storing material is applied to the first area 221 or both the first area 221 and the second area 222 of the reflector 200. An image of the seahorse 52 is therefore displayed as an afterimage on the reflection surface 220 even in a case where the image light from the projector 100 is not projected on the reflection surface 220. The user can therefore feel as if the user caught a sea-swimming creature.

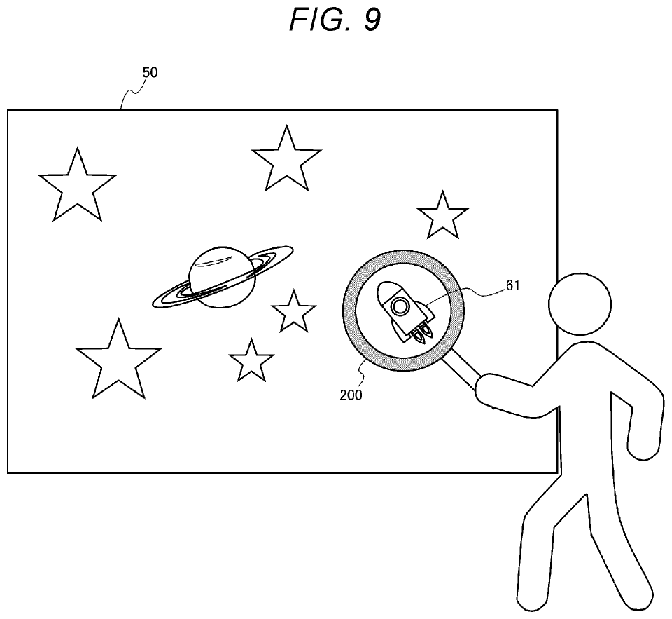

The case where a sea-swimming creature is caught with the reflector 200, on which a net picture is drawn, has been described with reference to FIGS. 7 and 8, but the image projected by the projector 100 is not limited to an image of a submarine object. For example, FIG. 9 shows a case where the projector 100 projects image light containing the outer space and a partial image showing a rocket 61, which flies in the outer space, on the projection surface 50. The partial image showing the rocket 61 moves in the outer space, which forms the overall image, and the position where the partial image is displayed changes in the overall image.

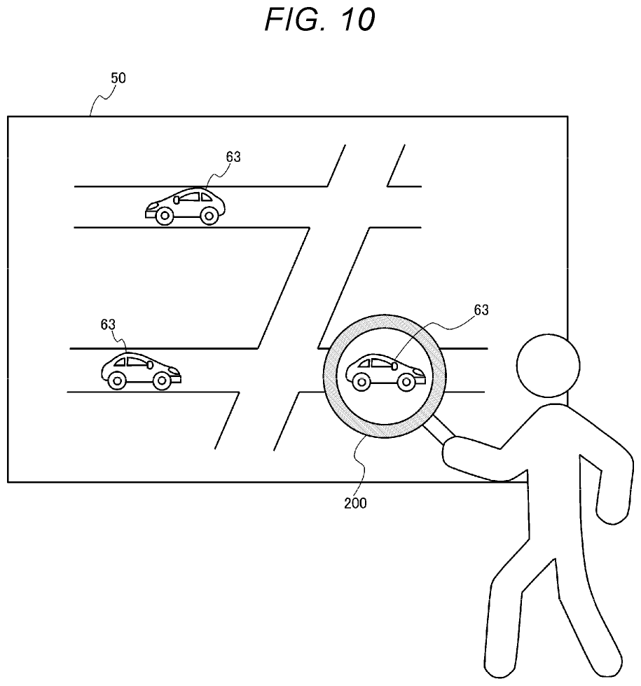

FIG. 10 shows a case where the projector 100 projects image light containing a road and partial images showing vehicles 63, which travel along the road, on the projection surface 50. The partial images showing the vehicles 63 move along the road displayed in the overall image, and the positions where the partial images are displayed change in the overall image.

The user holds the reflector 200 with ahead and moves the reflector 200 while viewing the image projected on the projection surface 50 to catch the rocket 61 moving in the outer space or any of the vehicles 63 traveling along the road. The user places the first area 221 of the reflector 200 in the position of the rocket 61 or any of the vehicles 63 that the user desires to capture so that the partial image showing the rocket 61 or any of the vehicle 63 is projected in the first area 221.

The display system 1 according to the present embodiment includes the projector 100, which projects image light on the projection surface 50, and the reflector 200, which includes the gripper 210 and the reflection surface 220, over which the reflective material having the light scattering capability is uniformly disposed.

Therefore, when the reflector 200, which has the reflection surface 220 having the light scattering capability, is irradiated with the image light projected by the projector 100, the user can visually recognize an image based on the image light. The image projected by the projector can therefore be used to provide the user with fun and enjoyment, such as those provided by a game.

The light storing material is added to the reflective material or part thereof.

Therefore, when the reflection surface 220 is irradiated with the image light, an afterimage of the image corresponding to the image light can be displayed on the reflection surface 220.

The reflection surface 220 has the first area 221 and the second area 222 having reflectance lower than the reflectance of the first area 221.

Therefore, when the reflection surface 220 is irradiated with the image light, the user can visually recognize images having different luminance values. The user can therefore manipulate the reflector 200 in such a way that the first area 221 is irradiated with the image light. Further, since the image projected on the second area 222 is difficult to see as compared with the image projected on the first area 221, the feature of a game that causes the user to search for a desired image projected on the projection surface 50 can be enhanced.

The first area 221 is formed in a central area containing the center of the reflection surface 220, and the second area 222 is formed around the first area 221.

Therefore, when the first area 221 is irradiated with the image light, the luminance of the image visually recognized by the user increases. The user can therefore recognize that the first area 221 is irradiated with the image light.

The reflector 200 includes the light detector 251, which detects light with which the reflection surface 220 is irradiated, the vibration section 253, which produces vibration to cause the gripper 210 to vibrate, and the reflector controller 252, which causes the vibration section 253 to vibrate based on the result of the detection performed by the light detector 251.

Therefore, in the case where the reflection surface 220 is irradiated with light, the gripper 210 vibrates to notify the user that the reflection surface 220 is being irradiated with the image light.

The image projected by the projector 100 on the projection surface 50 is formed by the image light representing motion images or partial motion images so produced that a specific area of a still image moves.

The feature of a game that causes the user to capture an image of a moving portion with the reflector 200 can therefore be imparted.

Part of the reflection surface 220 transmits the image light and scatters the transmitted image light toward a side of the reflection surface 220 that is the side opposite the side irradiated with the image light. Observation of the scattered light therefore allows observation of a portion cut from video images, whereby the expandability of the game can be further enhanced.

The embodiment described above is a preferable form in which the present disclosure is implemented. The present disclosure is, however, not limited to the embodiment described above, and a variety of changes can be made thereto to the extent that the changes do not depart from the substance of the invention.

For example, the above embodiment has been described with reference to the configuration in which the projector 100 includes a liquid crystal panel, and the liquid crystal panel may be a transmissive or reflective liquid crystal panel. Further, the liquid crystal panel may be replaced with a digital mirror device.

The functional portions of the projector 100 shown in FIG. 3 each represent a functional configuration and is not necessarily implemented in a specific form. That is, hardware corresponding to each of the functional portions is not necessarily implemented, and a single processor that executes a program can, of course, achieve the functions of the plurality of functional portions. Further, part of the functions achieved by software in the embodiment described above may be achieved by hardware, or part of the functions achieved by hardware may be achieved by software. In addition, the specific detailed configuration of each of the other portions of the projector can be arbitrarily changed to the extent that the change does not depart from the substance of the invention.

What is claimed is:

1. A display system comprising:
a projector configured to project image light; and
a reflector including a gripper and a reflection surface over which a reflective material having light scattering capability is uniformly disposed.

2. The display system according to claim 1, wherein a light storing material is added to the reflective material or part thereof.

3. The display system according to claim 1, wherein the reflection surface has a first area and a second area having reflectance lower than reflectance of the first area.

4. The display system according to claim 3, wherein the first area is formed in a central area containing a center of the reflection surface, and the second area is formed around the first area.

5. The display system according to claim 1, further comprising:
a light receptor that receives light with which the reflection surface is irradiated;
a vibration section that produces vibration to cause the gripper to vibrate; and
a controller that causes the vibration section to vibrate based on a result of the light reception performed by the light receptor.

6. The display system according to claim 1, wherein the projector projects the image light on a projection surface in the form of motion images or partial motion images so produced that a specific portion of an image moves.

7. The display system according to claim 1, wherein part of the reflection surface transmits the image light and scatters the transmitted image light toward a side of the reflection surface that is a side opposite a side irradiated with the image light.
